(19) United States
(12) Patent Application Publication
(10) Pub. No.: US 2026/0349143 A1
(43) Pub. Date: Nov. 5, 2026

(54) SYSTEMS AND METHODS FOR PREDICTING AND AVOIDING MOBILE HOME DAMAGE BASED UPON TELEMATICS DATA

(71) Applicant: State Farm Mutual Automobile Insurance Company, Bloomington, IL (US)

(72) Inventor: Christopher N. Otterman, Bloomington, IL (US)

(21) Appl. No.: 19/442,403

(22) Filed: Jan. 7, 2026

Related U.S. Application Data
(60) Provisional application No. 63/942,272, filed on Dec. 16, 2025.
(60) Provisional application No. 63/798,317, filed on May 1, 2025.

(51) Int. Cl. G01W 1/10; G06N 5/022

(52) U.S. Cl. CPC G01W 1/10; G06N 5/022; G01W 2203/00

(57) ABSTRACT

A telematics computing system may include a processor programmed to: (i) wirelessly connect to a weather services computer device; (ii) receive telematics data associated with travel of a mobile home; (iii) receive current weather data from the weather services computer device; (iv) input the telematics data and the current weather data into a machine learning model; (v) receive an output from the machine learning model associated with a potentially anomalous weather event associated with the mobile home; (vi) determine a mitigating location different the current location; and/or (vii) cause an alert to be transmitted to a user device associated with an occupant of the mobile home.

### CROSS REFERENCE TO RELATED APPLICATIONS

This Application claims the benefit of priority to U.S. Provisional Patent Application No. 63/942,272, filed Dec. 16, 2025, and to U.S. Provisional Patent Application No. 63/798,317, filed May 1, 2025, each of which is hereby incorporated by reference herein in its entirety.

### FIELD OF THE DISCLOSURE

The present disclosure relates to machine learning (ML) and artificial intelligence (AI) and, more particularly, to systems and methods that utilize ML and AI tools along with telematics data to predict and avoid damage incurred to a mobile home or recreational vehicle.

### BACKGROUND

Today, mobile homes (e.g., motorhomes and/or recreational vehicles (RVs)) are used in many different ways. As an example, some mobile homes may be used only once or twice a year, while other mobile homes may be used for a majority of the year. As another example, certain mobile homes may be taken to areas associated with more potential damage than others.

Mobile homes may also be a bigger expense than many other vehicles. Thus, when damage to a mobile home occurs (e.g., hail damage), the cost of repair or replacement may be highly burdensome.

Yet further, mobile homes may be frequently more exposed to damage than other vehicles based upon the way mobile homes are used (e.g., for outdoor and/or high-adventure activities). For instance, certain mobile homes may be used for trips to higher-risk areas such as mountains, deserts, remote areas, and/or areas having fast-moving wildlife, as examples. Some of these areas may be more prone to severe weather, natural disasters, wildfires, and/or other events that potentially could result in damage to the mobile homes. In some cases, a mobile home may be driven through high traffic areas (e.g., congested cities) on the way to a destination which further adds to the risk of damage occurring to the mobile home.

Prior techniques for predicting and/or avoiding potential damage to mobile homes include many drawbacks including a lack of telematics data and/or weather data associated with mobile homes. Further, known techniques for providing insurance policies covering mobile homes may involve pricing policies that are based upon a home location of the mobile home, and not how or where the mobile home is used away from the home location (e.g., travel locations and/or duration of travel). Conventional techniques may include additional inefficiencies, encumbrances, ineffectiveness, and/or other drawbacks.

### BRIEF SUMMARY

The present embodiments may generally relate to, inter alia, computer systems and computer-based methods that quickly, accurately, and/or comprehensively predict mobile home damage and provide recommendations for avoiding potential mobile home damage. More specifically, a telematics computing system for predicting and/or avoiding damage to a mobile home may be provided in various embodiments. Additionally, in certain embodiments, a computer system and/or computer-implemented method may include and/or be associated with mobile home insurance, or the like.

For example, the present embodiments of the systems and methods described herein may include artificial intelligence (AI) models that are specifically trained to correlate historical weather data with a time of year aspect, a location aspect, a damage aspect from a weather event having occurred, and/or a cost to repair a mobile home that may have experienced damage as a result of the weather event. Accordingly, the AI models described herein may be specifically trained to predict damage incurred by a mobile home from a weather event based on past weather events, locations, time of year, etc. Thus, predicted damage may be predicted with minimal data provided to the models such as when and where the mobile home will be taken and for how long. In some cases, this data may be provided by the owner of the mobile home or the data may be provided by telematics sensors associated with the mobile home that tell the models where the mobile home has been, at what time, and/or for how long. In some embodiments, the AI models may be trained to receive current weather data from sensors and/or from third-party sources. The current weather data may then be used to predict likely damage to a mobile home from an upcoming weather event and/or provide recommendations regarding how to mitigate the predicted damage to the mobile home. The specially trained AI models described herein provide a significant improvement over conventional systems that may be used to assess and/or predict potential damage to a mobile home.

In one aspect, a telematics computing system may be provided. The telematics computing system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and/or other electronic or electrical components, which may be in wired or wireless communication with one another, and act as input/output devices.

For example, in one aspect, a telematics computing system may include a memory, a plurality of sensors, and a processor in communication with the memory. The processor may be programmed to: (i) wirelessly connect to a weather services computer device that generates weather data associated with a plurality of locations; (ii) receive telematics data associated with travel of the mobile home at least partially collected by the plurality of sensors, the telematics data including a plurality of travel locations of the mobile home and a plurality of durations of time spent by the mobile home at the plurality of travel locations; (iii) receive current weather data from the weather services computer device wherein the current weather data is associated with at least one location of the plurality of travel locations; (iv) input the telematics data and the current weather data into the machine learning model, the machine learning model trained to assess potentially anomalous weather events with respect to mobile homes based upon historical telematics data and historical weather data; (v) receive an output from the machine learning model associated with a potentially anomalous weather event associated with the mobile home; (vi) determine a mitigating location different the current location that would potentially mitigate damage to the mobile home by the potentially anomalous weather event; and/or (vii) cause an alert to be transmitted to a user device associated with an occupant of the mobile home, the alert including an indication of the potentially anomalous weather event and a recommendation to travel to the mitigating location. The telematics computing system may include additional, less, or alternate functionality, including that discussed elsewhere herein.

In another aspect, at least one non-transitory computer-readable storage medium with instructions stored thereon for tracking activity associated with a plurality of mobile homes using a machine learning model is described. The instructions, when executed by at least one processor, may cause the at least one processor to: (i) wirelessly connect to a weather services computer device that generates weather data associated with a plurality of locations; (ii) receive telematics data associated with travel of a mobile home at least partially collected by a plurality of sensors associated with the mobile home, the telematics data including a plurality of travel locations of the mobile home and a plurality of durations of time spent by the mobile home at the plurality of travel locations; (iii) receive current weather data from the weather services computer device wherein the current weather data is associated with at least one location of the plurality of travel locations; (iv) input the telematics data and the current weather data into the machine learning model, the machine learning model trained to assess potentially anomalous weather events with respect to mobile homes based upon historical telematics data and historical weather data; (v) receive an output from the machine learning model associated with a potentially anomalous weather event associated with the mobile home; (vi) determine a mitigating location different the current location that would potentially mitigate damage to the mobile home by the potentially anomalous weather event; and/or (vii) cause an alert to be transmitted to a user device associated with an occupant of the mobile home, the alert including an indication of the potentially anomalous weather event and a recommendation to travel to the mitigating location. The at least one non-transitory computer-readable storage medium may include additional, less, or alternate functionality, including that discussed elsewhere herein.

In another aspect, a computer-implemented method for tracking activity associated with a plurality of mobile homes using a machine learning model is described. The computer-implemented method may be implemented by at least one processor in communication with at least one memory. The computer-implemented method may include: (i) wirelessly connecting to a weather services computer device that generates weather data associated with a plurality of locations; (ii) receiving telematics data associated with travel of a mobile home at least partially collected by a plurality of sensors associated with the mobile home, the telematics data including a plurality of travel locations of the mobile home and a plurality of durations of time spent by the mobile home at the plurality of travel locations; (iii) receiving current weather data from the weather services computer device wherein the current weather data is associated with at least one location of the plurality of travel locations; (iv) inputting the telematics data and the current weather data into the machine learning model, the machine learning model trained to assess potentially anomalous weather events with respect to mobile homes based upon historical telematics data and historical weather data; (v) receiving an output from the machine learning model associated with a potentially anomalous weather event associated with the mobile home; (vi) determining a mitigating location different the current location that would potentially mitigate damage to the mobile home by the potentially anomalous weather event; and/or (vii) causing an alert to be transmitted to a user device associated with an occupant of the mobile home, the alert including an indication of the potentially anomalous weather event and a recommendation to travel to the mitigating location. The computer-implemented method may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates an exemplary computing system for predicting and avoiding mobile home damage based upon telematics data according to an exemplary embodiment of the present disclosure.

FIG. 2 illustrates an exemplary configuration of a server computing device according to an exemplary embodiment of the present disclosure.

FIG. 3 illustrates an exemplary mobile home according to an exemplary embodiment of the present disclosure.

FIG. 4 illustrates an exemplary configuration of a user computer device according to an exemplary embodiment of the present disclosure.

FIG. 5 illustrates another exemplary configuration of a server computing device according to an exemplary embodiment of the present disclosure.

FIG. 6 illustrates an exemplary computer-implemented method of predicting mobile home damage according to an exemplary embodiment of the present disclosure.

FIG. 7 illustrates an exemplary computer-implemented method of predicting and avoiding mobile home damage according to an exemplary embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, potential mobile home damage and, more particularly, to systems and methods for predicting and avoiding mobile home damage based upon telematics data. An example system may collect and/or generate data associated with a mobile home (e.g., telematics data) and assess potential damage that may occur to a mobile home based upon the collected data. Further, an exemplary computer system may collect and/or generate data associated with a vehicle (e.g., different from the mobile home) to determine a potentially anomalous weather event associated with the mobile home and/or recommend that the mobile home be taken to a mitigating location (e.g., in proximity to a current location of the mobile home) that would potentially mitigate damage done to the mobile home.

In an exemplary embodiment, a device (e.g., a mobile device of a user and/or another device (e.g., a mobile home controller) associated with a mobile home) may include and/or be in communication with sensors associated with a mobile home. For instance, the device may be a mobile device of a user executing an exemplary application installed thereon. The device may be in communication with a server computer device.

The device may generate telematics data (e.g., based upon inputs from the sensors) associated with the mobile home. The device may be in communication with a weather service device and/or may be configured to generate weather alerts based upon weather data received from the weather service device and a current and/or future location of the mobile home. For instance, the device may utilize global positioning system (GPS) technology to track a current location, previous locations, and/or predict future locations of the mobile home. In some examples, a user may be able to plan a future trip in an application (e.g., via a trip planning feature) and enter future locations where they plan to take the mobile home and/or when they plan to take the mobile home to the future locations. In some examples, the device may allow the user to provide an input (e.g., indicating that a trip has begun) in order to enable alerts sent from the device to a user device associated with the user.

During a trip, if the example system described herein determines that a weather event may be in the path of a mobile home (e.g., based upon weather data and/or telematics data such as GPS coordinates associated with the mobile home), the system may generate an alert associated with the weather event and/or transmit the alert to a user device associated with a user of the mobile home. The system may predict that a potentially anomalous weather event may occur and/or transmit one or more alerts to the user device at various times before the potentially anomalous weather event is predicted to occur (e.g., at predetermined times before, such as one hour and/or thirty minutes) in order to allow for sufficient time for the mobile home to detour (e.g., and/or avoid the potentially anomalous weather event).

As an example, the system may identify one or more mitigating locations (e.g., covered locations such as a parking garage, truck stop, at a state park, next to a building, under tree cover, away from the anomalous weather event) and/or transmit an alert to the user device identifying the one or more mitigating locations and/or defining one or more routes to the one or more mitigating locations (e.g., a selected mitigating location (e.g., automatically or by a user) of the one or more mitigating locations).

In some embodiments, the system may transmit instructions regarding scheduling parking at a mitigating location (e.g., instructions to purchase a pre-paid parking ticket, an access code that automatically opens a door or barricade of the covered parking location). As another example, the system may transmit an alert that includes an alternate travel route (e.g., with less exposure to a weather event) additionally and/or alternatively to a mitigating location at which to park the mobile home. Further, the system may transmit an alert if the mobile home is parked at a campground (e.g., for an extended period of time) and it would be beneficial for the mobile home to move from the campground to a mitigating location.

In the exemplary embodiment, the example system may utilize gathered telematics data associated with a mobile home in order to generate and/or modify a policy (e.g., and/or renewal of a policy) associated with the mobile home. For instance, telematics data such as acceleration data, braking data, speed data, cornering data, heading or direction data, route data, location data, and/or other vehicle telematics data may be utilized to determine aspects and/or factors associated with a policy such as body injury and/or property damage potential (BIPD), medical payment coverage (MPC), personal injury protection (PIP), collision coverage (COLL), and/or comprehensive coverage (COMP).

The telematics data may be utilized along with weather data to cross reference weather that occurred at locations of the mobile home. For instance, a weighted average location of the mobile home may be generated based upon the telematics data and weather data associated with that weighted average location may be utilized to determine potential damage and/or risk associated with the mobile home. In some embodiments, a plurality of weighted average locations are determined based upon different time periods (e.g., at a home location for 2 months, away from the home location at a first weighted average location for 4 months, away from the home location at a second weighted average location for six months). As another example, a distributional estimate of locations may be utilized based upon the telematics data (e.g., in a garage for 8 months, on the road at various locations for 4 months), along with weather data associated with times the mobile home was at the various locations, to determine potential damage and/or risk associated with the mobile home.

Accordingly, the system described herein improves upon prior systems based upon the extensive amount of information generated, gathered, and/or utilized (e.g., to predict potential damage for a mobile home). For instance, the present system may cross reference and/or overlay location data with historical and/or current weather data (e.g., via severe convective storm risk maps) to determine potential exposure of a mobile home to weather events, predict potential damage to the mobile home, and/or provide recommendations regarding avoiding the potential damage (e.g., and/or provide recommendations regarding pricing a policy according to the potential damage).

In some embodiments, a device (e.g., a mobile device of a user and/or another device (e.g., a mobile home controller) associated with a mobile home) configured to generate telematics data may operate in a standby and/or low battery mode when a mobile home is not in use in order to minimize battery usage.

In some cases, a weather incident may be the primary cause of property damage, however, secondary factors such as mobile home data (e.g., materials used to build a mobile home) may contribute to the potential mobile home damage or make the mobile home more susceptible to damage caused by a weather incident. For example, for a specific weather incident, an older mobile home may be more easily damaged than a younger mobile home. As another example, mobile homes with more weatherproofing features and/or materials may be less susceptible to damage than mobile homes with fewer weatherproofing features and/or materials.

Further, secondary factors may include historical animal collision data associated with collisions between mobile homes and/or other vehicles in certain locations. For instance, certain regions may be associated with more collisions between mobile homes and/or vehicles with wildlife. As another example, certain regions may be associated with more off-road encounters between mobile homes and/or vehicles with wildlife (e.g., animals damaging stationary and/or parked mobile homes).

At least one technical problem addressed by the present embodiments may include: (a) inability of computing devices to analyze current telematics data and/or historical telematics data to identify travel locations and/or duration of travel of mobile homes; (b) inability of computing devices to receive and/or analyze inputs in various formats; (c) inability of computing devices to identify potential damage related to mobile homes based upon telematics data and/or weather data; and/or (d) inability of computing devices to identify and/or provide travel instructions to locations that could potentially mitigate damage to mobile homes.

A technical effect of the present embodiments may be achieved by performing at least one of the following: (a) retrieving mobile home data from memory, the mobile home data including physical characteristics of the mobile home and a home location of the mobile home; (b) receiving telematics data associated with travel of the mobile home at least partially collected by the plurality of sensors, the telematics data including a plurality of travel locations of the mobile home and/or a plurality of durations of time spent by the mobile home at the plurality of travel locations; (c) inputting the telematics data into the machine learning model, the machine learning model configured to assess a likelihood of damage occurring to the mobile home based upon the telematics data and historical weather data associated with the plurality of travel locations, the machine learning model trained to assess damages resulting from use of the mobile home; and/or (d) receiving an output from the machine learning model including an assessment associated with the likelihood of damage occurring to the mobile home.

A technical effect of the present embodiments may be achieved by further performing at least one of the following: (a) wirelessly connecting to a weather services computer device that generates weather data associated with a plurality of locations; (b) receiving telematics data associated with travel of the mobile home at least partially collected by the plurality of sensors, the telematics data including a plurality of travel locations of the mobile home and/or a plurality of durations of time spent by the mobile home at the plurality of travel locations; (c) receiving current weather data from the weather services computer device wherein the current weather data is associated with at least one location of the plurality of travel locations; (d) inputting the telematics data and the current weather data into the machine learning model, the machine learning model trained to assess potentially anomalous weather events with respect to mobile homes based upon historical telematics data and/or historical weather data; (e) receiving an output from the machine learning model associated with a potentially anomalous weather event associated with the mobile home; (f) determining a mitigating location different the current location that would potentially mitigate damage to the mobile home by the potentially anomalous weather event; and/or (g) causing an alert to be transmitted to a user device associated with an occupant of the mobile home, the alert including an indication of the potentially anomalous weather event and/or a recommendation to travel to the mitigating location.

At least one technical improvement and/or solution implemented by the present embodiments may include: (a) ability to analyze current telematics data and/or historical telematics data to identify travel locations and/or duration of travel of mobile homes (e.g., via a machine learning model); (b) ability to receive and/or analyze inputs in various formats; (c) ability to identify potential damage related to mobile homes based upon telematics data and/or weather data (e.g., via a machine learning model); (d) ability to identify and/or provide travel instructions to locations that could potentially mitigate damage to mobile homes (e.g., via a machine learning model); (e) leveraging input feature engineering tools to generate input features for machine learning models to identify potentially risky travel locations and/or timing periods; (f) training, re-training, and/or updating one or more machine learning algorithms and/or tools with input features for identifying potential damage to a mobile home based on location, timing, and/or past weather events; (g) accurate prediction of damage to a mobile home based upon minimal input into a specially trained AI model which minimizes the computation resources needed to make such predictions; (h) conservation of significant amounts of computational resources; (i) improving the precision of AI/ML models in predicting potential damage to mobile homes; (j) ability to analyze a wide variety of parameters and dimensions in connection with mobile home usage; (k) creating and/or utilizing machine learning models that include the ability to evaluate risk factors of a current location and/or trip (e.g., future planned locations) of a mobile home based upon historical data and current data; (l) real-time evaluation of mobile homes using input features of a model; (m) improved quality of historical training data for AI/ML models; (n) increased accessibility to covered parking locations for mobile homes; and/or (o) increased awareness for mobile home users of the availability and/or location of covered parking locations.

In an exemplary embodiment, a telematics computing device for collecting telematics data associated with mobile homes and analyzing the telematics data using a machine learning model is described. The telematics computing device may include at least one memory with instructions stored thereon, a plurality of sensors associated with a mobile home for collecting at least some telematics data, and/or at least one processor in communication with the at least one memory and the plurality of sensors wherein the instructions, when executed by the at least one processor, cause the at least one processor to retrieve mobile home data from the at least one memory, the mobile home data including physical characteristics of the mobile home and a home location of the mobile home, and/or receive telematics data associated with travel of the mobile home at least partially collected by the plurality of sensors, the telematics data including a plurality of travel locations of the mobile home and/or a plurality of durations of time spent by the mobile home at the plurality of travel locations. The instructions may also cause the at least one processor to input the telematics data into the machine learning model, the machine learning model configured to assess a likelihood of damage occurring to the mobile home based upon the telematics data and historical weather data associated with the plurality of travel locations, the machine learning model trained to assess damages resulting from use of the mobile home, and/or receive an output from the machine learning model including an assessment associated with the likelihood of damage occurring to the mobile home.

In some embodiments, the instructions may further cause the at least one processor to receive second telematics data associated with the mobile home at least partially collected by the plurality of sensors, the second telematics data including a second plurality of travel locations of the mobile home and a second plurality of durations of time spent by the mobile home at the second plurality of travel locations, input the second telematics data into the machine learning model, and/or receive a second output from the machine learning model including a second assessment associated with a second likelihood of damage occurring to the mobile home.

In some embodiments, the instructions may further cause the at least one processor to, prior to receiving the telematics data, generate a baseline policy associated with the mobile home based upon the mobile home data. In some embodiments, the instructions may further cause the at least one processor to, based upon the output from the machine learning model, cause at least one update to be made to the baseline policy.

In some embodiments, the instructions may further cause the at least one processor to receive the telematics data from at least one of a mobile home monitoring device coupled to the mobile home or a mobile device associated with an occupant of the mobile home.

In some embodiments, the physical characteristics of the mobile home may include at least one device of the mobile home and/or at least one component of the mobile home.

In some embodiments, the mobile home may be one of a motorhome or a recreational vehicle (RV).

In some embodiments, the machine learning model may be trained to assess damages resulting from use of the mobile home based upon at least one of historical mobile home data, the historical weather data, and/or historical telematics data.

In an exemplary embodiment, a telematics computing device configured to track activity associated with mobile homes using a machine learning model is described. The telematics computing device may include at least one memory with instructions stored thereon, a plurality of sensors associated with a mobile home for collecting at least some telematics data, and/or at least one processor in communication with the at least one memory and the plurality of sensors. The instructions, when executed by the at least one processor, may cause the at least one processor to wirelessly connect to a weather services computer device that generates weather data associated with a plurality of locations and/or receive telematics data associated with travel of the mobile home at least partially collected by the plurality of sensors, the telematics data including a plurality of travel locations of the mobile home and/or a plurality of durations of time spent by the mobile home at the plurality of travel locations. The instructions may further cause the at least one processor to receive current weather data from the weather services computer device wherein the current weather data is associated with at least one location of the plurality of travel locations and/or input the telematics data and the current weather data into the machine learning model, the machine learning model trained to assess potentially anomalous weather events with respect to mobile homes based upon historical telematics data and/or historical weather data. The instructions may also cause the at least one processor to receive an output from the machine learning model associated with a potentially anomalous weather event associated with the mobile home, determine a mitigating location different the current location that would potentially mitigate damage to the mobile home by the potentially anomalous weather event, and/or cause an alert to be transmitted to a user device associated with an occupant of the mobile home, the alert including an indication of the potentially anomalous weather event and/or a recommendation to travel to the mitigating location.

In some embodiments, the instructions may further cause the at least one processor to generate at least part of the telematics data associated with travel of the mobile home. In some embodiments, the instructions may further cause the at least one processor to transmit the telematics data to a policy computing device wherein the policy computing device is configured to generate a policy associated with the mobile home based at least in part upon the telematics data.

In some embodiments, the instructions may further cause the at least one processor to further input the telematics data to the machine learning model, the machine learning model further trained to identify mitigating locations that would potentially mitigate damage to mobile homes from potentially anomalous weather events, receive the output wherein the output is further associated with the mitigating location, and/or determine the mitigating location based upon the output. In some embodiments, the machine learning model may be further trained based upon map data including pluralities of fully-covered locations, pluralities of partially-covered locations, and/or pluralities of locations that are not covered.

In some embodiments, the instructions may further cause the at least one processor to determine the mitigating location at the telematics computing device based upon the telematics data.

In some embodiments, the instructions may further cause the at least one processor to cause the alert to be transmitted to the user device by one of transmitting the alert to the user device or causing a remote device to transmit the alert to the user device.

In some embodiments, the telematics data may further include a current location of the mobile home, and the instructions may further cause the at least one processor to determine a travel path from the current location to the mitigating location and/or transmit travel instructions associated with the travel path to the user device. In some embodiments, the instructions may further cause the at least one processor to determine that the current location is an uncovered location with either little or no coverage overhead the mobile home. In some embodiments, the mitigating location may be a covered location including overhead coverage provided by at least one of a manmade structure or a natural structure. In some embodiments, the manmade structure may be a parking garage and the natural structure may include at least one tree.

In some embodiments, the instructions may further cause the at least one processor to determine the mitigating location from a plurality of mitigating locations based at least in part upon historical mitigating data associated with damage previously mitigated by the plurality of mitigating locations.

### EXEMPLARY COMPUTER SYSTEM

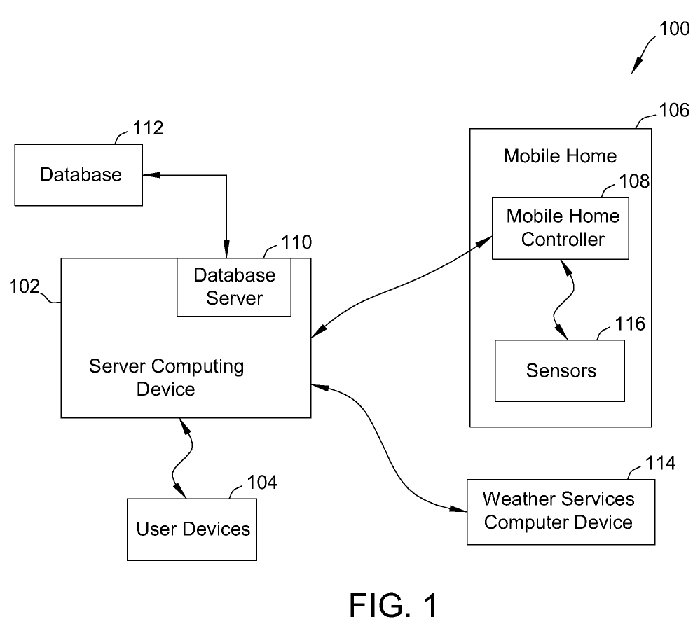

FIG. 1 depicts a simplified block diagram of an exemplary computer system 100. In the exemplary embodiment, system 100 may be used for predicting and/or avoiding mobile home damage (e.g., using AI-based tools). In the exemplary embodiment, system 100 may include a server computing device 102, one or more user computing devices 104 in communication with server computing device 102, and one or more mobile homes 106 (e.g., including a mobile home controller 108 in communication with server computing device 102).

User computer devices 104 may be computers that include a web browser and/or a software application, which may enable user computer devices 104 to access server computing device 102 using the Internet. More specifically, user computer devices 104 may be communicatively coupled to the Internet through many interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and/or a cable modem.

User computer devices 104 may be devices capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, a drone, chat bots, other web-based connectable equipment or mobile devices, and/or some combination thereof.

A database server 110 may be communicatively coupled to a database 112 that stores data. Database 112 may include data relating to mobile homes 106 and their users, as described in further detail herein. In some embodiments, database 112 may be stored remotely from server computing device 102 and/or may be decentralized. In the exemplary embodiment, a person may access database 112 via user computer devices 104 by logging onto server computing device 102, as described herein.

In certain embodiments, server computing device 102 may be associated with or may be part of a computer network associated with an organization (e.g., business, group, school, organization or other user associated network) and/or in communication with a computer network associated with the organization. In some embodiments, server computing device 102 may be associated with a third party and is merely in communication with the organization’s computer network. One or more weather services computer devices 114 (e.g., servers) may be in communication with server computing device 102. The one or more weather services computer devices 114 (e.g., servers) each may be associated with a weather service provider and may provide data regarding historical weather data and/or current weather data to server computing device 102, as described herein.

For example, weather data (e.g., obtained via one or more APIs from a commercial weather vendor or National Weather Service (NWS)) may include hail size, hail location, hail date, wind speed, wind direction, and/or temperature.

As another example, weather data may include U.S. climate regions recognized by the Building America (BA) program and climate zones recognized by the International Energy Conservation Code (IECC). The BA climate regions may be similar to the IECC climate zones. In some embodiments, climate locality may refer to a climate region designated by the BA program and/or a climate zone designated by the IECC. Server computing device 102 may use alternative and/or additional climate locality designations.

The BA climate regions are based upon heating degree days, average temperature, and precipitation. The BA climate regions include the following eight regions: BA Region 1: Hot-Humid; BA Region 2: Mixed-Humid; BA Region 3: Hot-Dry; BA Region 4: Mixed-Dry; BA Region 5: Cold; BA Region 6: Very-Cold, BA Region 7: Subarctic, and BA Region 8: Marine.

The IECC designates climate zones: Zone 1, Zone 2, Zone 3, Zone 4, Zone 5, Zone 6, Zone 7, and Zone 8. In addition, the IECC identifies three moisture regimes identified by the IECC including A: Moist, B: Dry, and C: Marine. Accordingly, the IECC designates a total of 11 total climate localities. The 11 climate localities include: Zone 0A Extremely Hot Humid, Zone 0B Extremely Hot Dry, Zone 1A Very Hot Humid, Zone 1B Very Hot Dry, Zone 2A Hot Humid, Zone 2B Hot Dry, Zone 3A Warm Humid, Zone 3B Warm Dry, Zone 3C Warm Marine, Zone 4A Mixed Humid, Zone 4B Mixed Dry, Zone 4C Mixed Marine, Zone 5A Cool Humid, Zone 5B Cool Dry, Zone 5C Cool Marine, Zone 6A Cold Humid, Zone 6B Cold Dry, Zone 7 Very Cold, Zone 8 Subarctic/Arctic.

In some embodiments, weather data may be received by server computing device 102 via an application programming interface (API) associated with weather service computing device 114 and may be presented as a heat map, which relates weather severity levels with location data. The heat map may be presented in graphical format, showing a color-coded severity level gradient overlaid with a geographic map showing locations of active policies. In some embodiments, the heat map may be formatted in a table relating severity level with geographic location. In some embodiments, the heat map may be overlaid upon one or more weighted average locations of a mobile home and/or a current location of a mobile home.

In some embodiments, weather data may include climate data, received from one or more climate sources (e.g., via one or more APIs). The climate source may include, for example and without limitation, U.S. government funded data compiled by the Pacific Northeast National Laboratory and the Oakridge Laboratory for the U.S. Department of Energy’s Building America Program. In some embodiments, the climate source may include the International Energy Conservation Code (IECC), International Residential Building (IRC) code, and/or the American Society of Heating, Refrigerating and Air-Conditioning Engineers (ASHRAE). In some embodiments, server computing device 102 may receive climate data, directly or indirectly, from additional and/or alternative climate sources. Server computing device 102 may subsequently store the climate data within database 112.

In some embodiments, the weather sources, e.g., commercial vendor weather service international and/or the National Weather Service (NWS), may transmit one or more messages to server computing device 102 using the API. For example, a weather incident may trigger the weather source to transmit the one or more messages, e.g., an alert message, to server computing device 102 and/or a computing device associated with a user and/or an insurance provider. In some embodiments, server computing device 102 may receive weather incident data by executing an API to access the weather data from a weather source.

Weather data may include any one or more of the following: weather incident signature, a date and time, e.g., start time and/or an end time, at which the weather incident occurred, and a duration of time over which the weather incident occurred. Weather incident data may include one or more of the following: hail size, wind speed, wind direction, pressure, and temperature. Weather incident data may include a heat map indicating a severity of the weather incident relative to a location of the weather incident. For example, the heat map may include hail sizes and/or hail total volume in a specific location. Hail size may include hail weight, hail diameter, hail shape (e.g., smooth, jagged, and/or spiked etc.), hail volume, hail hardness (e.g., a measure of resistance against deformation upon impact and/or the hail’s resistance to flexing), and/or hail density (e.g., how compact the ice is). For example, layers of ice may accumulate as a hailstone grows within a storm. Often, air bubbles can be trapped in these layers making the hailstone less dense and/or “softer.”

The API may transmit weather data, e.g., hail size, location, and/or a weather heat map. The weather heat map may include a relationship between location data and a severity of weather incident data, e.g., hail size. In some embodiments, the weather heat map may be displayed as a color-coded scale of severity level (e.g., red – increased severity and blue – low severity) overlaid onto a locational map of a region in which the weather incident occurred. The heat map may include one or more regions on a location map that are circumscribed by a polygon and are color-coded with the same severity level.

Mobile homes 106 may each include a respective mobile home controller 108 and one or more sensors 116 in communication with mobile home controller 108. Sensors 116 may include, for example, audio sensors, video sensors, diagnostic sensors mounted within the vehicle, and/or other types of sensors for detecting and/or measuring parameters associated with the mobile home (e.g., internal and/or external). Server computing device 102 may be configured to receive mobile home data (e.g., telematics data) from mobile home controller 108 of a selected mobile home 106. The mobile home data may be collected by one or more sensors 116 in communication with mobile home controller 108 and may relate to at least one of a plurality of mobile home subsystems of mobile home 106. For example, the mobile home data may include audio data, video data, mobile home diagnostic data and/or other types of sensor data that are associated with mobile home 106 for describing a parameter that may be used for inspecting mobile home 106.

As described above, server computing device 102 system may further include or be in communication with one or more user computing devices 104 such as, for example, a smart phone, tablet smart glasses, a VR headset, an AR headset, and/or a different smart wearable device. In some embodiments, in addition to receiving the vehicle data from mobile home 106 itself, server computing device 102 may receive additional mobile home data from one or more user computing devices 104 (e.g., a user mobile device and/or other computing device). This additional mobile home data may include, for example, audio data, video data, image data, and/or text data that is input via user computing device 104 and/or telematics data (e.g., generated by one or more sensors of user computing device 104).

Server computing device 102 may be configured to communicate with a computer application executed on user computing device 104 and/or mobile home controller 108 and may receive telematics data associated with mobile home 106 via the computer application. For instance, a request message may cause server computing device 102 to retrieve the telematics data from mobile home controller 108 or user computing device 104.

Server computing device 102 may be further configured to execute a first AI model (or any number of AI models) that is configured to analyze telematics data associated with mobile home 106. As an example, telematics data associated with mobile home 106 may include location data associated with locations where mobile home 106 has traveled and durations during which mobile home 106 has stayed at those locations. For instance, certain mobile homes may remain at a “home” location (e.g., in a garage) for extended periods of time while other mobile homes may travel more frequently. As another example, certain mobile homes may travel to city locations (e.g., more densely populated locations) more often while certain mobile homes may travel to rural locations more often.

Based upon the telematics data for mobile home 106, the first AI model may be trained to identify potential future mobile home damage of mobile home 106 based upon historical data associated with historical and/or current locations of mobile home 106. As one example, mobile homes that travel into cities more frequently (e.g., and/or on freeways associated with a high frequency of accidents) may be associated with more potential mobile home damage because of the higher amounts of traffic and more narrow streets in cities. As another example, mobile homes that travel to certain rural locations (e.g., mountains, certain areas with more frequent natural disasters such as tornadoes, mudslides, flooding, rockfall, and/or severe storms) may be associated with more potential mobile home damage because of their potential to be exposed to certain weather events. As a further example, historical animal collision data (e.g., associated with animal collisions with vehicles) may be analyzed to identify locations associated with more frequent animal collisions than others. Other potential sources for damage to mobile homes are envisioned within the scope of the present disclosure.

Accordingly, the first AI model may be trained to identify locations of mobile homes and/or damage associated with the locations of mobile homes based upon historical data associated with the locations of the mobile home (e.g., weather data and/or other incident data) and/or other data associated with the mobile home (e.g., age of the mobile home, quality of the mobile home).

Outputs from the first AI model may include recommendations for alternate locations of travel for mobile home 106 (e.g., locations associated with less potential damage) and/or a potential damage profile associated with mobile home 106 (e.g., that could be used to generate and/or modify a policy, such as an insurance policy, associated with mobile home 106).

The first AI model may include at least one of a large language model (LLM), a small language model (SLM), a machine learning (ML) model, computer vision tools, and/or a Generative AI model.

Server computing device 102 may further be configured to execute a second AI model (or any number of AI models) associated with avoiding potential mobile home damage. The second AI model may include at least one of an LLM, an SLM, an ML model, computer vision tools, and/or a Generative AI model. In some embodiments, the first AI model and the second AI model may be different or executed separately from each other. In some embodiments, the first AI model and the second AI model may be the same AI model.

As an example, the second AI model may receive inputs such as telematics data associated with mobile home 106 (e.g., including a current location and/or travel path of mobile home 106) and/or weather data associated with mobile home 106 (e.g., current or predicted weather events associated with a current and/or predicted future location of mobile home 106). The second AI model may analyze the inputs and provide outputs that include one or more travel recommendations for mobile home 106 to avoid potential weather events.

For instance, the second AI model may be trained based upon historical data (e.g., historical damage to vehicles at various locations based upon various weather events) to identify travel recommendations for locations for mobile homes to travel to based upon historical damage to vehicles at various locations based upon various historical weather events and/or a current potential weather event associated with a mobile home.

In some embodiments, the second AI model may identify that mobile home 106 is in an uncovered and/or exposed location and output an alternate, covered location (e.g., (e.g., garages, parking decks, parking lots with roofs, bridges providing cover underneath, warehouses, and/or any locations configured to house a mobile home). As one example, the second AI model may identify that mobile home 106 is traveling toward and/or is parked in a location where a hailstorm may occur. Accordingly, the second AI model may identify a covered location, such as a nearby parking garage, that mobile home 106 could travel to in order to avoid potential damage from the hailstorm (e.g., based upon a historical lack of damage to vehicles at the parking garage during historical hailstorms).

In some embodiments, server computing device 102 and/or mobile home controller 108 may be configured to transmit a request to reserve a parking spot, payment information (e.g., a payment card number, a bank account number, etc.), and/or a mobile home profile to a parking computing device associated with a parking location. Server computing device 102 and/or mobile home controller 108 may be configured to store the payment information and/or the mobile home profile. The mobile home profile may include information associated with mobile home 106 and/or one or more mobile home users (e.g., drivers) of mobile home 106 to provide the parking computing device with information to determine whether to accept or decline the request to reserve the parking spot. In some embodiments, the mobile home profile may include, a background check of a mobile home user, peer reviews, ratings, and/or the make and model of mobile home 106. The parking computing device may respond (e.g., via transmission to mobile home controller 108 and/or user devices 104) with a parking pass (e.g., digital, such as a QR code) or other means to access the parking garage and/or spot associated therewith, as examples.

In some embodiments, server computing device 102 may transmit directions to a covered location (e.g., based upon an output from the second AI model) to a device associated with mobile home 106 (e.g., user computing device 104 and/or mobile home controller 108) in order to assist with travel to the covered location. In some embodiments, server computing device 102 may transmit instructions associated with purchase of a parking pass to allow mobile home 106 access to a garage and/or other parking area.

In some embodiments, server computing device 102 may receive telematics data associated with mobile home 106 and determine whether or not mobile home 106 traveled to a location recommended by the second AI model and/or update a profile associated with mobile home 106 based upon whether mobile home 106 traveled to the recommended location or not (e.g., and/or one or more policies associated with mobile home 106 may be updated by the avoidance, or lack thereof, of potential damage).

Further example inputs to server computing device 102 and/or an AI model may include a live or recorded video stream data, image data, audio data, diagnostic data and/or other vehicle data.

In some embodiments, server computing device 102 may be further configured to train a plurality of AI models (e.g., the first AI model and the second AI model) using historical data associated with mobile home 106 and/or other mobile homes. This historical data may include, for example mobile home manufacturer’s data, mobile home schematic data, common issues and solutions data for mobile homes located via the Internet, expert insight data, mobile home repair data, map data (e.g., identifying covered and/or uncovered locations), mobile software data, insurance claims data, historical weather data, and/or other data.

Server computing device 102 may be further configured to store a mobile home profile associated with mobile home 106 in one or more memory devices such as database 112. The stored mobile home profile may include, for mobile home 106, mobile home data, telematics data associated with mobile home 106, potential damage data associated with mobile home 106, and/or historical weather data associated with mobile home 106.

Server computing device 102 may continually update the stored mobile home profile with subsequently collected mobile home data, telematics data associated with mobile home 106, potential damage associated with mobile home 106, and/or historical weather data associated with mobile home 106 and indications as to whether potential damage was avoided by mobile home 106.

### EXEMPLARY COMPUTING DEVICE FOR EXECUTING A MODEL

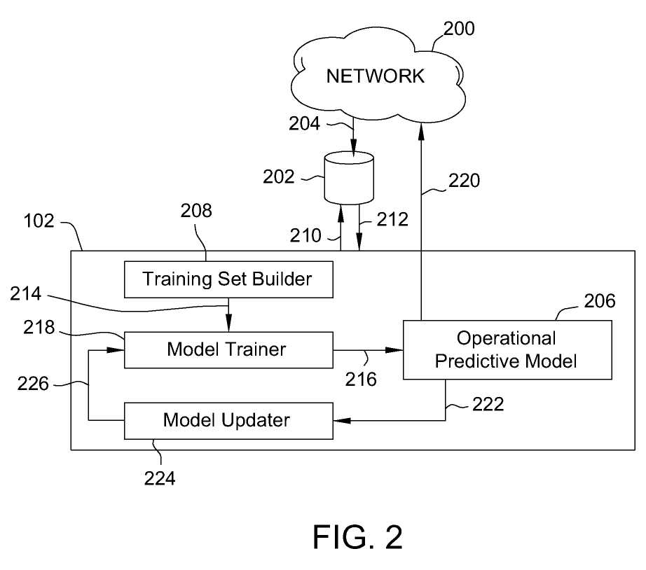

FIG. 2 is a schematic diagram illustrating further detail of server computing device 102 (shown in FIG. 1) according to some embodiments. Server computing device 102 may communicate with other components of system 100 via a network 200. Server computing device 102 may include and/or be in communication with a database 202 that stores data 204 including historical telematics data and/or historical weather data. Data 204 received from network 200 may be stored in database 202. Server computing device 102 may be configured to use data 204 to generate an operational predictive model module 206 for predicting mobile home damage and/or avoiding mobile home damage (e.g., generating recommendations to avoid mobile home damage) as described herein.

In some embodiments, server computing device 102 includes a training set builder module 208 configured to submit one or more queries 210 to database 202 to retrieve subsets 212 of data 204, and to use those subsets 212 to build training data sets 214 for generating operational predictive model 216. For example, query 210 may be configured to retrieve certain fields from data 204 having certain similar aspects, such as historical weather data having common patterns and/or features with current weather data (e.g., associated with mobile home 106) historical telematics data having common patterns and/or features with current telematics data (e.g., associated with mobile home 106) and/or historical vehicle damage data associated with historical damage to vehicles based upon historical events (e.g., weather events, animal collision events, vehicle collision events).

In some embodiments, training set builder module 208 may be configured to derive training data sets 214 from retrieved subsets 212. Each training data set 214 may correspond to historical data 204 (“historical” in this context means completed in the past, as opposed to completed in real-time with respect to the time of retrieval by training set builder module 208). Each training data set 214 may include “model input” data fields along with at least one “result” data field representing historical feedback. The model input data fields may represent factors that may be expected to, or unexpectedly be found during model training to, have some correlation with data values and/or features of mobile homes 106.

In exemplary embodiments, the model input data fields in training data sets 214 may be generated from data fields in subset 212 corresponding to historical data 204. In other words, a trained ML model 216 produced by a model trainer module 218 for use by operational predictive model module 206 may be trained to make predictions based on input values that can be generated from the data fields in data 204. Values in the model input data fields may include values copied directly from values in a corresponding data field in the retrieved subset 212, and/or values generated by modifying, combining, or otherwise operating upon values in one or more data fields in the retrieved subset 212. The use of such data fields as model input data fields facilitates the ML model in weighing these factors directly.

After training set builder module 208 generates training data sets 214, training set builder module 208 passes the training data sets 214 to model trainer module 218. In some embodiments, model trainer module 218 is configured to apply the model input data fields of each training data set 214 as inputs to one or more ML models. Each of the one or more ML models may be programmed to produce, for each training data set 214, at least one output intended to correspond to, or “predict,” a value of the at least one result data field of the training data set 214. “Machine learning” refers broadly to various algorithms that may be used to train the model to identify and recognize patterns in existing data in order to facilitate making predictions for subsequent new input data.

Model trainer module 218 may be configured to compare, for each training data set 214, the at least one output of the model to the at least one result data field of the training data set 214 and apply a ML algorithm to adjust parameters of the model in order to reduce the difference or “error” between the at least one output and the corresponding at least one result data field. In this way, model trainer module 218 trains the ML model to accurately predict the value of the at least one result data field.

In other words, model trainer module 218 cycles the one or more ML models through the training data sets 214, causing adjustments in the model parameters, until the error between the at least one output and the at least one result data field falls below a suitable threshold, and then uploads at least one trained ML model 216 to operational predictive model module 206 for application to generating predictions 220. In exemplary embodiments, model trainer module 218 may be configured to simultaneously train multiple candidate ML models and to select the best performing candidate for each result data field, as measured by the “error” between the at least one output and the corresponding result data field, to upload to operational predictive model module 206.

In some embodiments, the one or more ML models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 218 cycles through the training data sets 214, model trainer module 218 may apply a suitable backpropagation algorithm to adjust the weights in each node layer to minimize the error between the at least one output and the corresponding result data field. In this fashion, the ML model may be trained to produce output that reliably predicts the corresponding result data field. In some embodiments, the ML model may have any suitable structure.

In some embodiments, model trainer module 218 provides an advantage by automatically discovering and properly weighting complex, second- or third order, and/or otherwise nonlinear interconnections between the model input data fields and the at least one output. Absent the ML model, such connections are unexpected and/or undiscoverable by human analysts.

In exemplary embodiments, operational predictive model module 206 may compare feedback (e.g., feedback received from mobile home operators, and/or decisions made by mobile home operators based upon previous recommendations) and may route a comparison result 222 generated by comparing prediction 220 to the feedback to a model updater module 224 of server computing device 102. Model updater module 224 may be configured to derive a correction signal 226 from comparison results 222 received for one or more predictions 220, and to provide correction signal 226 to model trainer module 218 to enable updating or “re-training” of the at least one ML model to improve performance. The retrained at least one ML model 216 may be periodically re-uploaded to operational predictive model module 206.

Further, server computing device 102 may use data from user computing devices 104 and/or mobile home controller 108 as historical data 204, training data sets 214, validation data, and/or other data as needed during the training, retraining, and/or execution of the one or more AI models.

In some embodiments, server computing device 102 trains multiple models wherein each model is for analyzing a different data type, vehicle type, and/or any other variation or division desired to improve the operation of system 100 described herein.

### EXEMPLARY CONNECTED VEHICLE

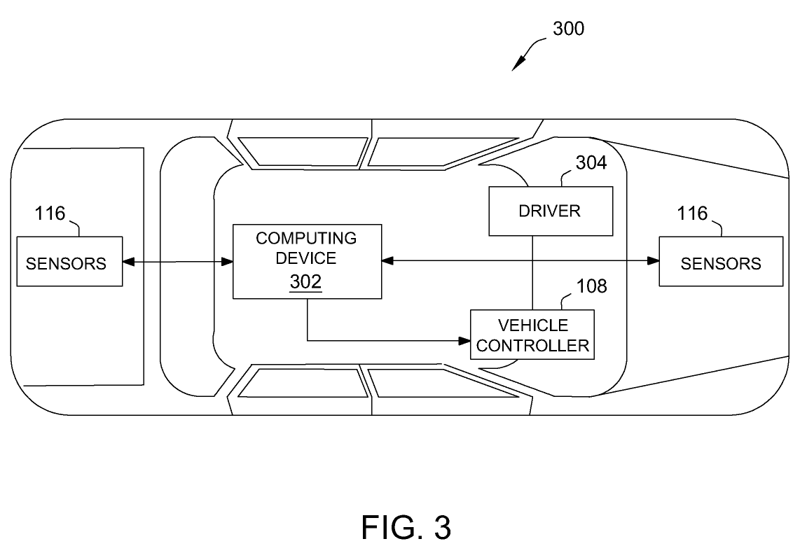

FIG. 3 depicts an exemplary embodiment of mobile home 106. In some embodiments, mobile home 106 may be a conventional and/or at least partially autonomous automobile, a recreational vehicle (RV), a motorcycle, a bicycle, a boat, an airplane, a powered scooter (e.g., an electric scooter), and/or another vehicle.

Mobile home 106 may include a plurality of sensors 116 and/or a computing device 302. Sensors 116 may include, but are not limited to, temperature sensors, terrain sensors, weather sensors, accelerometers, gyroscopes, radar, LIDAR, Global Positioning System (GPS), video devices, imaging devices, cameras (e.g., 2D and 3D cameras), audio recorders, and/or computer vision. In some embodiments, sensors 116 may be used to collect, for example, vehicle data and/or telematics data. Such vehicle data and/or telematics data collected by sensors 116 may be transmitted to server computing device 102.

Computing device 302 may be implemented, for example, as one of user computing devices 104. In some embodiments, computing device 302 and/or mobile home controller 108 may receive data from sensors 116. In some embodiments in which server computing device 102 is remote from mobile home 106, computing device 302 and/or mobile home controller 108 may transmit data received from sensors 116 (e.g., vehicle data and/or telematics data) to server computing device 102. Alternatively, server computing device 102 may be implemented as computing device 302.

In exemplary embodiments, mobile home controller 108 may control at least some operation of mobile home 106. For example, mobile home controller 108 may steer, accelerate, or decelerate mobile home 106 based upon data received, for example, from sensors 116. In some embodiments, mobile home controller 108 may include a display screen or touchscreen (not shown) that is capable of displaying information to and/or receiving input from driver 304.

In some embodiments, mobile home controller 108 may be capable of wirelessly communicating with a user mobile device such as user computing device 104. In some embodiments, mobile home controller 108 may be capable of communicating with the user of user computing device 104, such as driver 304, through an application on user computing device 104.

### EXEMPLARY USER COMPUTING DEVICE

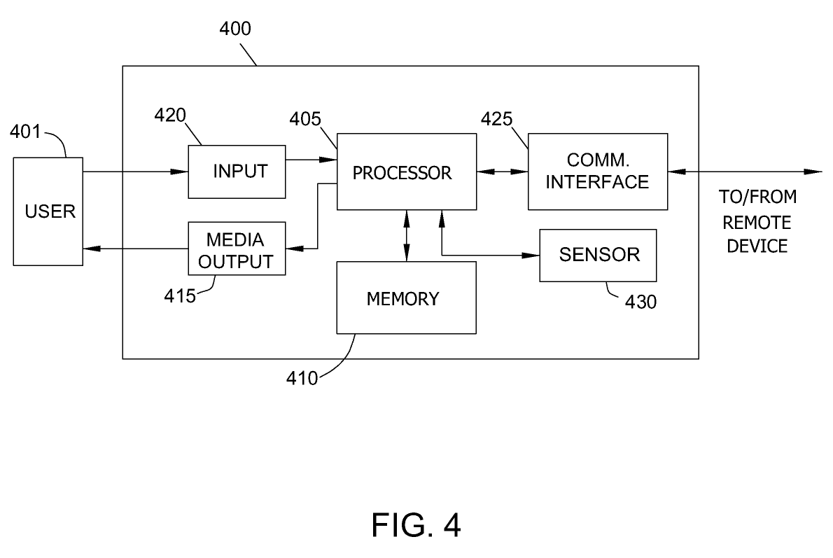

FIG. 4 depicts an exemplary user computing device 400, which may be an exemplary configuration of user computing device 104 shown in FIG. 1, in accordance with some embodiments of the present disclosure. User computing device 400 may be operated by a user 401. User computing device 400 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computing device 400 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively couplable to an output device such as a display device (e.g., a cathode ray tube (CRT), liquid crystal display (LCD), light emitting diode (LED) display, or “electronic ink” display), an audio output device (e.g., a speaker or headphones), and/or other display devices.

Input device 420 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 415 and input device 420.

User computing device 400 may also include a communication interface 425, communicatively coupled to a remote device such as server computing device 102 (shown in FIG. 1). Communication interface 425 may include, for example, a wired or wireless network adapter and/or a wireless data transceiver for use with a mobile telecommunications network.

Stored in memory area 410 may be, for example, computer readable instructions for providing a user interface to user 401 via media output component 415 and/or receiving and processing input from input device 420. A user interface may include, among other possibilities, a web browser and/or a client application. Web browsers enable users, such as user 401, to display and/or interact with media and other information typically embedded on a web page or a website from server computing device 102.

A client application allows user 401 to interact with, for example, server computing device 102. For example, instructions may be stored by a cloud service, and the output of the execution of the instructions sent to media output component 415. Processor 405 executes computer-executable instructions for implementing aspects of the disclosure. In some embodiments, processor 405 is transformed into a special purpose microprocessor by executing computer-executable instructions or by otherwise being programmed.

### EXEMPLARY SERVER COMPUTING DEVICE

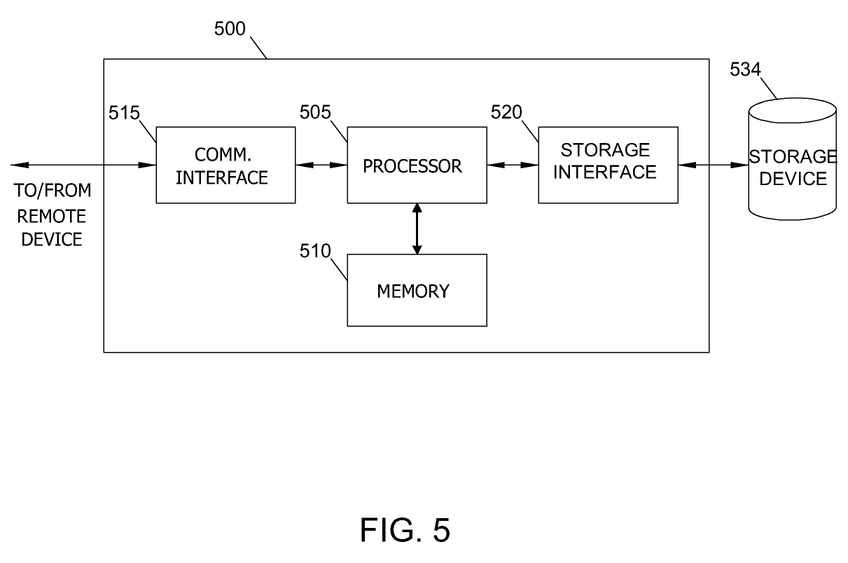

FIG. 5 depicts an exemplary configuration of a server computing device 500, in accordance with some embodiments of the present disclosure. Server computer device 500 may include, but is not limited to, server computing device 102 and/or weather services computer device 114 (shown in FIG. 1). Server computer device 500 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 500 is capable of communicating with a remote device such as another server computer device 500, user computing devices 104, and/or mobile home controllers 108 (shown in FIG. 1). For example, communication interface 515 may receive requests from user computing devices 104 and/or mobile home controllers 108 via the Internet.

Processor 505 may also be operatively coupled to a storage device 534. Storage device 534 may be any computer-operated hardware suitable for storing and/or retrieving data, such as, but not limited to, data associated with database 112 (shown in FIG. 1). In some embodiments, storage device 534 may be integrated in server computer device 500. For example, server computer device 500 may include one or more hard disk drives as storage device 534.

In some embodiments, storage device 534 may be external to server computer device 500 and may be accessed by a plurality of server computer devices 500. For example, storage device 534 may include a storage area network (SAN), a network attached storage (NAS) system, and/or multiple storage units such as hard disks and/or solid-state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, processor 505 may be transformed into a special purpose microprocessor by executing computer-executable instructions or by otherwise being programmed.

### EXEMPLARY COMPUTER-IMPLEMENTED METHOD FOR PREDICTING MOBILE HOME DAMAGE

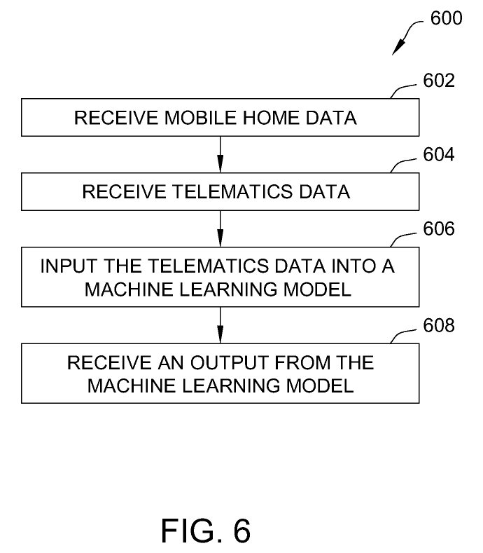

FIG. 6 illustrates an exemplary computer-implemented method 600 for predicting mobile home damage (e.g., to mobile home 106). Computer-implemented method 600 may be implemented by system 100 (e.g., server computing device 102 in communication with mobile home 106, user computing devices 104, and/or weather services computer device 114).

Computer-implemented method 600 may include retrieving 602 mobile home data from at least one memory, the mobile home data including physical characteristics of the mobile home and/or a home location of the mobile home, and/or receiving 604 telematics data associated with travel of the mobile home at least partially collected by the plurality of sensors, the telematics data including a plurality of travel locations of the mobile home and/or a plurality of durations of time spent by the mobile home at the plurality of travel locations. Computer-implemented method 600 may also include inputting 606 the telematics data into a machine learning model, the machine learning model configured to assess a likelihood of damage occurring to the mobile home based upon the telematics data and/or historical weather data associated with the plurality of travel locations, the machine learning model trained to assess damages resulting from use of the mobile home, and/or receiving 608 an output from the machine learning model including an assessment associated with the likelihood of damage occurring to the mobile home.

In some embodiments, computer-implemented method 600 may include receiving second telematics data associated with the mobile home at least partially collected by the plurality of sensors, the second telematics data including a second plurality of travel locations of the mobile home and/or a second plurality of durations of time spent by the mobile home at the second plurality of travel locations, inputting the second telematics data into the machine learning model, and/or receiving a second output from the machine learning model including a second assessment associated with a second likelihood of damage occurring to the mobile home.

In some embodiments, computer-implemented method 600 may include, prior to receiving the telematics data, generating a baseline policy associated with the mobile home based upon the mobile home data. In some embodiments, computer-implemented method 600 may include, based upon the output from the machine learning model, causing at least one update to be made to the baseline policy.

In some embodiments, computer-implemented method 600 may include receiving the telematics data from at least one of a mobile home monitoring device coupled to the mobile home or a mobile device associated with an occupant of the mobile home.

In some embodiments of computer-implemented method 600, the physical characteristics of the mobile home may include at least one device of the mobile home and/or at least one component of the mobile home.

In some embodiments of computer-implemented method 600, the mobile home may be one of a motorhome or a recreational vehicle (RV).

In some embodiments of computer-implemented method 600, the machine learning model may be trained to assess damages resulting from use of the mobile home based upon at least one of historical mobile home data, the historical weather data, and/or historical telematics data.

### EXEMPLARY COMPUTER-IMPLEMENTED METHOD FOR PREDICTING AND AVOIDING MOBILE HOME DAMAGE

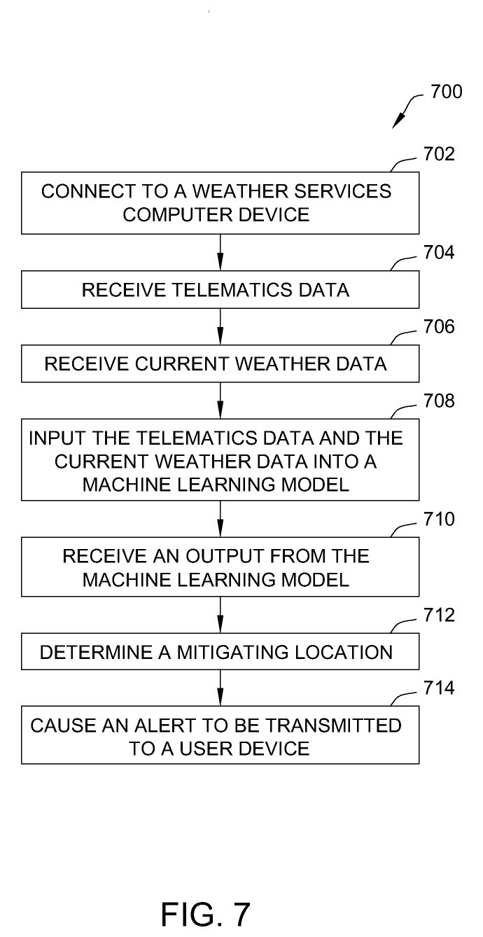

FIG. 7 illustrates an exemplary computer-implemented method 700 for predicting and avoiding mobile home damage (e.g., to mobile home 106). Computer-implemented method 700 may be implemented by system 100 (e.g., server computing device 102 in communication with mobile home 106, user computing devices 104, and/or weather services computer device 114).

Computer-implemented method 700 may include wirelessly connecting 702 to a weather services computer device that generates weather data associated with a plurality of locations and/or receiving 704 telematics data associated with travel of the mobile home at least partially collected by the plurality of sensors, the telematics data including a plurality of travel locations of the mobile home and/or a plurality of durations of time spent by the mobile home at the plurality of travel locations. Computer-implemented method 700 may also include receiving 706 current weather data from the weather services computer device wherein the current weather data is associated with at least one location of the plurality of travel locations and/or inputting 708 the telematics data and/or the current weather data into the machine learning model, the machine learning model trained to assess potentially anomalous weather events with respect to mobile homes based upon historical telematics data and/or historical weather data. Computer-implemented method 700 may further include receiving 710 an output from the machine learning model associated with a potentially anomalous weather event associated with the mobile home, determining 712 a mitigating location different the current location that would potentially mitigate damage to the mobile home by the potentially anomalous weather event, and/or causing 714 an alert to be transmitted to a user device associated with an occupant of the mobile home, the alert including an indication of the potentially anomalous weather event and/or a recommendation to travel to the mitigating location.

In some embodiments, computer-implemented method 700 may include generating at least part of the telematics data associated with travel of the mobile home. In some embodiments, computer-implemented method 700 may include transmitting the telematics data to a policy computing device wherein the policy computing device is configured to generate a policy associated with the mobile home based at least in part upon the telematics data.

In some embodiments, computer-implemented method 700 may include further inputting the telematics data to the machine learning model, the machine learning model further trained to identify mitigating locations that would potentially mitigate damage to mobile homes from potentially anomalous weather events, receiving the output wherein the output is further associated with the mitigating location, and/or determining the mitigating location based upon the output. In some embodiments of computer-implemented method 700, the machine learning model may be further trained based upon map data including pluralities of fully-covered locations, pluralities of partially-covered locations, and/or pluralities of locations that are not covered.

In some embodiments, computer-implemented method 700 may include determining the mitigating location at the telematics computing device based upon the telematics data.

In some embodiments, computer-implemented method 700 may include causing the alert to be transmitted to the user device by one of transmitting the alert to the user device or causing a remote device to transmit the alert to the user device.

In some embodiments of computer-implemented method 700, the telematics data may further include a current location of the mobile home, and computer-implemented method 700 may further include determining a travel path from the current location to the mitigating location and/or transmitting travel instructions associated with the travel path to the user device. In some embodiments, computer-implemented method 700 may include determining that the current location is an uncovered location with either little or no coverage overhead the mobile home. In some embodiments of computer-implemented method 700, the mitigating location is a covered location including overhead coverage provided by at least one of a manmade structure or a natural structure. In some embodiments of computer-implemented method 700, the manmade structure is a parking garage and/or the natural structure is at least one tree.

In some embodiments, computer-implemented method 700 may include determining the mitigating location from a plurality of mitigating locations based at least in part upon historical mitigating data associated with damage previously mitigated by the plurality of mitigating locations.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised ML, and the ML program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the ML programs may be trained by inputting sample data sets or certain data into the programs, such as image, mobile device, vehicle telematics, and/or intelligent home telematics data. The ML programs may utilize deep learning algorithms that may be primarily focused on pattern recognition and may be trained after processing multiple examples. The ML programs may include Bayesian program learning (BPL), voice recognition and synthesis, image or object recognition, optical character recognition, and/or natural language processing – either individually or in combination. The ML programs may also include natural language processing, semantic analysis, automatic reasoning, and/or ML.

In supervised ML, a processing element may be provided with example inputs and their associated outputs and may seek to discover a general rule that maps inputs to outputs, so that when subsequent novel inputs may be provided the processing element may, based upon the discovered rule, accurately predict the correct output. In unsupervised ML, the processing element may be required to find its own structure in unlabeled example inputs. In some embodiments, ML techniques may be used to extract the relevant personal belonging and/or home feature information for customers from mobile device sensors, vehicle-mounted sensors, home-mounted sensors, and/or other sensor data, vehicle or home telematics data, image data, and/or other data.

In some embodiments, a processing element may be trained by providing it with a large sample of conventional analog and/or digital, still and/or moving (e.g., video) image data, telematics data, other data of vehicle characteristics or features, map data, and/or weather data.

Based upon these analyses, the processing element may learn how to identify characteristics and patterns that may then be applied to analyzing telematics data, weather data, map data, and/or other data to identify locations of a mobile home, durations of time spent at locations by a mobile home, potential weather events associated with a mobile home, potential anomalous events associated with a mobile home (e.g., collisions), and/or mitigating locations that may mitigate potential damage caused to a mobile home.

In some embodiments, voice bots or chatbots, such as those discussed herein, may be configured to utilize AI and/or ML techniques. For instance, the chatbot may be an LLM such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

Input features for AI/ML models may be the individual, measurable attributes from a dataset that are used to train the model and make predictions. These features may be numerical (such as a number of data events that have occurred over a period of time) or categorical (such as different types of data). Techniques for feature creation and/or selection include feature engineering, which involves selecting, transforming, and creating features. Input features may be preprocessed in that raw data may be converted to numerical formats and/or scaling numerical data that is usable by a model. Input features may be derived based upon interaction variables (e.g., multiplying and/or dividing two variables together) and/or creating polynomial features (e.g., raising a variable to a power) that may help extract more nuanced information from data. Aspects of the present disclosure relate to various interaction variables and their relation to one another in the context of evaluating various parameters associated with mobile homes and/or their environments, as explained herein.

Data storage systems of the systems described herein may store data and/or other information/intelligence that indicates that a certain mobile home and/or type of mobile home has been associated certain types of damage in certain locations and/or at certain times of the year in the past (e.g., historical data). By engineering input features for ML models that are intended to detect and/or predict such damage from data patterns, the ML models become better-suited at recognizing similar events. This includes, for example, the ML models being configured to better recognize mobile homes that fit within certain data patterns and therefore may be more prone to significant damage.

The feature engineering techniques described herein may implement an item-based approach, including a target item (also referred to herein as a “target”) and a subject item (also referred to herein as a “subject”). A target or target item may be an item such as a type of mobile home that is associated with or exhibits certain data characteristics/patterns. A target or target item may be associated with identifying information and/or data such as a target identifier. A subject item may be an item such as specific mobile home that may be related to, associated with, or otherwise desired to be compared to/with the target item, for example to be used as a measuring tool for measuring aspects of certain data characteristics/patterns. A subject/subject item may be associated with identifying information and/or data such as a subject identifier.

### EXEMPLARY MOBILE HOME EMBODIMENTS

The present embodiments may relate to a telematics computing system for predicting and/or avoiding damage to a mobile home. In certain embodiments, a computer system and/or computer-implemented method may include and/or be associated with mobile home insurance, or the like.

In one aspect, a telematics computing device for collecting telematics data associated with mobile homes and analyzing the telematics data using a machine learning model is described. The telematics computing device may include at least one memory with instructions stored thereon, a plurality of sensors associated with a mobile home for collecting at least some telematics data, and/or at least one processor in communication with the at least one memory and the plurality of sensors wherein the instructions, when executed by the at least one processor, cause the at least one processor to retrieve mobile home data from the at least one memory, the mobile home data including physical characteristics of the mobile home and a home location of the mobile home, and/or receive telematics data associated with travel of the mobile home at least partially collected by the plurality of sensors, the telematics data including a plurality of travel locations of the mobile home and/or a plurality of durations of time spent by the mobile home at the plurality of travel locations. The instructions may also cause the at least one processor to input the telematics data into the machine learning model, the machine learning model configured to assess a likelihood of damage occurring to the mobile home based upon the telematics data and historical weather data associated with the plurality of travel locations, the machine learning model trained to assess damages resulting from use of the mobile home, and/or receive an output from the machine learning model including an assessment associated with the likelihood of damage occurring to the mobile home.

In some aspects, the instructions may further cause the at least one processor to receive second telematics data associated with the mobile home at least partially collected by the plurality of sensors, the second telematics data including a second plurality of travel locations of the mobile home and a second plurality of durations of time spent by the mobile home at the second plurality of travel locations, input the second telematics data into the machine learning model, and/or receive a second output from the machine learning model including a second assessment associated with a second likelihood of damage occurring to the mobile home.

In some aspects, the instructions may further cause the at least one processor to, prior to receiving the telematics data, generate a baseline policy associated with the mobile home based upon the mobile home data. In some aspects, the instructions may further cause the at least one processor to, based upon the output from the machine learning model, cause at least one update to be made to the baseline policy.

In some aspects, the instructions may further cause the at least one processor to receive the telematics data from at least one of a mobile home monitoring device coupled to the mobile home or a mobile device associated with an occupant of the mobile home.

In some aspects, the physical characteristics of the mobile home may include at least one device of the mobile home and/or at least one component of the mobile home. In some aspects, the mobile home may be one of a motorhome or a recreational vehicle (RV).

In some aspects, the machine learning model may be trained to assess damages resulting from use of the mobile home based upon at least one of historical mobile home data, the historical weather data, and/or historical telematics data.

In one aspect, at least one non-transitory computer-readable storage medium with instructions stored thereon for collecting mobile home telematics data associated with a plurality of mobile homes and analyzing the mobile home telematics data using a machine learning model is described. Execution of the instructions may cause the at least one processor to retrieve mobile home data from memory, the mobile home data including physical characteristics of a mobile home and a home location of the mobile home and/or receive telematics data associated with travel of the mobile home at least partially collected by a plurality of sensors associated with the mobile home, the telematics data including a plurality of travel locations of the mobile home and a plurality of durations of time spent by the mobile home at the plurality of travel locations. The instructions may also cause the at least one processor to input the telematics data into the machine learning model, the machine learning model configured to assess a likelihood of damage occurring to the mobile home based upon the telematics data and historical weather data associated with the plurality of travel locations, the machine learning model trained to assess damages resulting from use of the mobile home, and/or receive an output from the machine learning model including an assessment associated with the likelihood of damage occurring to the mobile home.

In some aspects, the instructions may further cause the at least one processor to receive second telematics data associated with the mobile home at least partially collected by the plurality of sensors, the second telematics data including a second plurality of travel locations of the mobile home and a second plurality of durations of time spent by the mobile home at the second plurality of travel locations, input the second telematics data into the machine learning model, and/or receive a second output from the machine learning model including a second assessment associated with a second likelihood of damage occurring to the mobile home.

In some aspects, the instructions may further cause the at least one processor to, prior to receiving the telematics data, generate a baseline policy associated with the mobile home based upon the mobile home data.

In some aspects, the instructions may further cause the at least one processor to, based upon the output from the machine learning model, cause at least one update to be made to the baseline policy.

In some aspects, the instructions may further cause the at least one processor to receive the telematics data from at least one of a mobile home monitoring device coupled to the mobile home or a mobile device associated with an occupant of the mobile home.

In some aspects, the physical characteristics of the mobile home may include at least one device of the mobile home and/or at least one component of the mobile home.

In some aspects, the mobile home may be one of a motorhome or a recreational vehicle (RV).

In some aspects, the machine learning model is trained to assess the damages resulting from use of the mobile home based upon at least one of historical mobile home data, the historical weather data, or historical telematics data.

In one aspect, a computer-implemented method for collecting mobile home telematics data associated with a plurality of mobile homes and analyzing the mobile home telematics data using a machine learning model is described. The computer-implemented method may be implemented by at least one processor in communication with at least one memory. The computer-implemented method may include retrieving mobile home data from the at least one memory, the mobile home data including physical characteristics of a mobile home and a home location of the mobile home, and/or receiving telematics data associated with travel of the mobile home at least partially collected by a plurality of sensors associated with the mobile home, the telematics data including a plurality of travel locations of the mobile home and a plurality of durations of time spent by the mobile home at the plurality of travel locations. The computer-implemented method may also include inputting the telematics data into the machine learning model, the machine learning model configured to assess a likelihood of damage occurring to the mobile home based upon the telematics data and historical weather data associated with the plurality of travel locations, the machine learning model trained to assess damages resulting from use of the mobile home, and/or receiving an output from the machine learning model including an assessment associated with the likelihood of damage occurring to the mobile home.

In some aspects, the computer-implemented method may further include receiving second telematics data associated with the mobile home at least partially collected by the plurality of sensors, the second telematics data including a second plurality of travel locations of the mobile home and a second plurality of durations of time spent by the mobile home at the second plurality of travel locations, inputting the second telematics data into the machine learning model, and/or receiving a second output from the machine learning model including a second assessment associated with a second likelihood of damage occurring to the mobile home.

In some aspects, the computer-implemented method may also include receiving the telematics data from at least one of a mobile home monitoring device coupled to the mobile home or a mobile device associated with an occupant of the mobile home.

In some aspects, the machine learning model may be trained to assess the damages resulting from use of the mobile home based upon at least one of historical mobile home data, the historical weather data, or historical telematics data.

In one aspect, a telematics computing device configured to track activity associated with mobile homes using a machine learning model is described. The telematics computing device may include at least one memory with instructions stored thereon, a plurality of sensors associated with a mobile home for collecting at least some telematics data, and/or at least one processor in communication with the at least one memory and the plurality of sensors. The instructions, when executed by the at least one processor, may cause the at least one processor to wirelessly connect to a weather services computer device that generates weather data associated with a plurality of locations and/or receive telematics data associated with travel of the mobile home at least partially collected by the plurality of sensors, the telematics data including a plurality of travel locations of the mobile home and/or a plurality of durations of time spent by the mobile home at the plurality of travel locations. The instructions may further cause the at least one processor to receive current weather data from the weather services computer device wherein the current weather data is associated with at least one location of the plurality of travel locations and/or input the telematics data and the current weather data into the machine learning model, the machine learning model trained to assess potentially anomalous weather events with respect to mobile homes based upon historical telematics data and/or historical weather data. The instructions may also cause the at least one processor to receive an output from the machine learning model associated with a potentially anomalous weather event associated with the mobile home, determine a mitigating location different the current location that would potentially mitigate damage to the mobile home by the potentially anomalous weather event, and/or cause an alert to be transmitted to a user device associated with an occupant of the mobile home, the alert including an indication of the potentially anomalous weather event and/or a recommendation to travel to the mitigating location.

In some aspects, the instructions may further cause the at least one processor to generate at least part of the telematics data associated with travel of the mobile home. In some aspects, the instructions may further cause the at least one processor to transmit the telematics data to a policy computing device wherein the policy computing device is configured to generate a policy associated with the mobile home based at least in part upon the telematics data.

In some aspects, the instructions may further cause the at least one processor to further input the telematics data to the machine learning model, the machine learning model further trained to identify mitigating locations that would potentially mitigate damage to mobile homes from potentially anomalous weather events, receive the output wherein the output is further associated with the mitigating location, and/or determine the mitigating location based upon the output. In some aspects, the machine learning model may be further trained based upon map data including pluralities of fully-covered locations, pluralities of partially-covered locations, and pluralities of locations that are not covered.

In some aspects, the instructions may further cause the at least one processor to determine the mitigating location at the telematics computing device based upon the telematics data. In some aspects, the instructions may further cause the at least one processor to cause the alert to be transmitted to the user device by one of transmitting the alert to the user device or causing a remoted device to transmit the alert to the user device.

In some aspects, the telematics data may further include a current location of the mobile home and the instructions may further cause the at least one processor to determine a travel path from the current location to the mitigating location and/or transmit travel instructions associated with the travel path to the user device. In some aspects, the instructions may further cause the at least one processor to determine that the current location is an uncovered location with either little or no coverage overhead the mobile home. In some aspects, the mitigating location may be a covered location including overhead coverage provided by at least one of a manmade structure or a natural structure. In some aspects, the manmade structure may be a parking garage and the natural structure includes at least one tree.

In some aspects, the instructions may further cause the at least one processor to determine the mitigating location from a plurality of mitigating locations based at least in part upon historical mitigating data associated with damage previously mitigated by the plurality of mitigating locations.

In one aspect, at least one non-transitory computer-readable storage medium with instructions stored thereon for tracking activity associated with a plurality of mobile homes using a machine learning model is described. The instructions, when executed by at least one processor, may cause the at least one processor to wirelessly connect to a weather services computer device that generates weather data associated with a plurality of locations and/or receive telematics data associated with travel of a mobile home at least partially collected by a plurality of sensors associated with the mobile home, the telematics data including a plurality of travel locations of the mobile home and a plurality of durations of time spent by the mobile home at the plurality of travel locations. The instructions may also cause the at least one processor to receive current weather data from the weather services computer device wherein the current weather data is associated with at least one location of the plurality of travel locations, and/or input the telematics data and the current weather data into the machine learning model, the machine learning model trained to assess potentially anomalous weather events with respect to mobile homes based upon historical telematics data and historical weather data. The instructions may also cause the at least one processor to receive an output from the machine learning model associated with a potentially anomalous weather event associated with the mobile home, determine a mitigating location different the current location that would potentially mitigate damage to the mobile home by the potentially anomalous weather event, and/or cause an alert to be transmitted to a user device associated with an occupant of the mobile home, the alert including an indication of the potentially anomalous weather event and a recommendation to travel to the mitigating location.

In some aspects, the instructions may further cause the at least one processor to generate at least part of the telematics data associated with travel of the mobile home. In some aspects, the instructions may further cause the at least one processor to transmit the telematics data to a policy computing device wherein the policy computing device is configured to generate a policy associated with the mobile home based at least in part upon the telematics data.

In some aspects, the machine learning model may be further trained based upon map data including pluralities of fully-covered locations, pluralities of partially-covered locations, and pluralities of locations that are not covered, and the instructions may further cause the at least one processor to further input the telematics data to the machine learning model, the machine learning model further trained to identify mitigating locations that would potentially mitigate damage to the mobile homes from the potentially anomalous weather events, receive the output wherein the output is further associated with the mitigating location, and/or determine the mitigating location based upon the output.

In some aspects, the telematics data may further include a current location of the mobile home, and the instructions may further cause the at least one processor to determine a travel path from the current location to the mitigating location and/or transmit travel instructions associated with the travel path to the user device.

In some aspects, the instructions may further cause the at least one processor to determine the mitigating location from a plurality of mitigating locations based at least in part upon historical mitigating data associated with damage previously mitigated by the plurality of mitigating locations.

In one aspect, a computer-implemented method for tracking activity associated with a plurality of mobile homes using a machine learning model is described. The computer-implemented method may be implemented by at least one processor in communication with at least one memory. The computer-implemented method may include wirelessly connecting to a weather services computer device that generates weather data associated with a plurality of locations and/or receiving telematics data associated with travel of a mobile home at least partially collected by a plurality of sensors associated with the mobile home, the telematics data including a plurality of travel locations of the mobile home and a plurality of durations of time spent by the mobile home at the plurality of travel locations. The computer-implemented method may also include receiving current weather data from the weather services computer device wherein the current weather data is associated with at least one location of the plurality of travel locations and/or inputting the telematics data and the current weather data into the machine learning model, the machine learning model trained to assess potentially anomalous weather events with respect to mobile homes based upon historical telematics data and historical weather data. The computer-implemented method may also include receiving an output from the machine learning model associated with a potentially anomalous weather event associated with the mobile home, determining a mitigating location different the current location that would potentially mitigate damage to the mobile home by the potentially anomalous weather event, and/or causing an alert to be transmitted to a user device associated with an occupant of the mobile home, the alert including an indication of the potentially anomalous weather event and a recommendation to travel to the mitigating location.

In some aspects, the computer-implemented method may also include further inputting the telematics data to the machine learning model, the machine learning model further trained to identify mitigating locations that would potentially mitigate damage to the mobile homes from the potentially anomalous weather events, receiving the output wherein the output is further associated with the mitigating location, and/or determining the mitigating location based upon the output.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples may be example only and may be thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples may be not intended to limit in any way the definition and/or meaning of the term database. Examples of RDBMS’s include, but may be not limited to, Oracle® Database, MySQL, IBM® DB2, Microsoft® SQL Server, Sybase®, and PostgreSQL. However, any database may be used that may enable the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.).

As used herein, the terms “software” and “firmware” may be interchangeable and include any computer program stored in memory for execution by a processor, including RAM memory, ROM memory, EPROM memory, EEPROM memory, and non-volatile RAM (NVRAM) memory. The above memory types may be example only and may be thus not limiting as to the types of memory usable for storage of a computer program.

In some embodiments, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system (e.g., system 100) includes multiple components distributed among a plurality of computer devices. One or more components may be in the form of computer-executable instructions embodied in a computer-readable medium. The systems and processes may be not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure may be not intended to be interpreted as excluding the existence of additional embodiments that also incorporate the recited features.

The patent claims at the end of this document may be not intended to be construed under 35 U.S.C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples may be intended to be within the scope of the claims if they have structural elements that do not differ from the literal language of the claims, or if they include equivalent structural elements with insubstantial differences from the literal language of the claims.

What is claimed is:

1. A telematics computing device configured to track activity associated with a plurality of mobile homes using a machine learning model, the telematics computing device comprising:
at least one memory with instructions stored thereon;
a plurality of sensors associated with a mobile home for collecting at least some telematics data; and
at least one processor in communication with the at least one memory and the plurality of sensors, wherein the instructions, when executed by the at least one processor, cause the at least one processor to:
wirelessly connect to a weather services computer device that generates weather data associated with a plurality of locations;
receive telematics data associated with travel of the mobile home at least partially collected by the plurality of sensors, the telematics data comprising a plurality of travel locations of the mobile home and a plurality of durations of time spent by the mobile home at the plurality of travel locations;
receive current weather data from the weather services computer device, wherein the current weather data is associated with at least one location of the plurality of travel locations;
input the telematics data and the current weather data into the machine learning model, the machine learning model trained to assess potentially anomalous weather events with respect to mobile homes based upon historical telematics data and historical weather data;
receive an output from the machine learning model associated with a potentially anomalous weather event associated with the mobile home;
determine a mitigating location different the current location that would potentially mitigate damage to the mobile home by the potentially anomalous weather event; and
cause an alert to be transmitted to a user device associated with an occupant of the mobile home, the alert comprising an indication of the potentially anomalous weather event and a recommendation to travel to the mitigating location.

2. The telematics computing device of claim 1, wherein the instructions further cause the at least one processor to generate at least part of the telematics data associated with travel of the mobile home.

3. The telematics computing device of claim 2, wherein the instructions further cause the at least one processor to transmit the telematics data to a policy computing device, wherein the policy computing device is configured to generate a policy associated with the mobile home based at least in part upon the telematics data.

4. The telematics computing device of claim 1, wherein the instructions further cause the at least one processor to:
further input the telematics data to the machine learning model, the machine learning model further trained to identify mitigating locations that would potentially mitigate damage to the mobile homes from the potentially anomalous weather events;
receive the output, wherein the output is further associated with the mitigating location; and
determine the mitigating location based upon the output.

5. The telematics computing device of claim 4, wherein the machine learning model is further trained based upon map data comprising pluralities of fully-covered locations, pluralities of partially-covered locations, and pluralities of locations that are not covered.

6. The telematics computing device of claim 1, wherein the instructions further cause the at least one processor to determine the mitigating location at the telematics computing device based upon the telematics data.

7. The telematics computing device of claim 1, wherein the instructions further cause the at least one processor to cause the alert to be transmitted to the user device by one of transmitting the alert to the user device or causing a remoted device to transmit the alert to the user device.

8. The telematics computing device of claim 1, wherein the telematics data further comprises a current location of the mobile home, and wherein the instructions further cause the at least one processor to:
determine a travel path from the current location to the mitigating location; and
transmit travel instructions associated with the travel path to the user device.

9. The telematics computing device of claim 8, wherein the instructions further cause the at least one processor to determine that the current location is an uncovered location with either little or no coverage overhead the mobile home.

10. The telematics computing device of claim 9, wherein the mitigating location is a covered location including overhead coverage provided by at least one of a manmade structure or a natural structure.

11. The telematics computing device of claim 10, wherein the manmade structure is a parking garage and wherein the natural structure comprises at least one tree.

12. The telematics computing device of claim 1, wherein the instructions further cause the at least one processor to determine the mitigating location from a plurality of mitigating locations based at least in part upon historical mitigating data associated with damage previously mitigated by the plurality of mitigating locations.

13. At least one non-transitory computer-readable storage medium with instructions stored thereon for tracking activity associated with a plurality of mobile homes using a machine learning model, wherein the instructions, when executed by at least one processor, cause the at least one processor to:
wirelessly connect to a weather services computer device that generates weather data associated with a plurality of locations;
receive telematics data associated with travel of a mobile home at least partially collected by a plurality of sensors associated with the mobile home, the telematics data comprising a plurality of travel locations of the mobile home and a plurality of durations of time spent by the mobile home at the plurality of travel locations;
receive current weather data from the weather services computer device, wherein the current weather data is associated with at least one location of the plurality of travel locations;
input the telematics data and the current weather data into the machine learning model, the machine learning model trained to assess potentially anomalous weather events with respect to mobile homes based upon historical telematics data and historical weather data;
receive an output from the machine learning model associated with a potentially anomalous weather event associated with the mobile home;
determine a mitigating location different the current location that would potentially mitigate damage to the mobile home by the potentially anomalous weather event; and
cause an alert to be transmitted to a user device associated with an occupant of the mobile home, the alert comprising an indication of the potentially anomalous weather event and a recommendation to travel to the mitigating location.

14. The at least one non-transitory computer-readable storage medium of claim 13, wherein the instructions further cause the at least one processor to generate at least part of the telematics data associated with travel of the mobile home.

15. The at least one non-transitory computer-readable storage medium of claim 14, wherein the instructions further cause the at least one processor to transmit the telematics data to a policy computing device, wherein the policy computing device is configured to generate a policy associated with the mobile home based at least in part upon the telematics data.

16. The at least one non-transitory computer-readable storage medium of claim 13, the machine learning model is further trained based upon map data comprising pluralities of fully-covered locations, pluralities of partially-covered locations, and pluralities of locations that are not covered, and wherein the instructions further cause the at least one processor to:
further input the telematics data to the machine learning model, the machine learning model further trained to identify mitigating locations that would potentially mitigate damage to the mobile homes from the potentially anomalous weather events;
receive the output, wherein the output is further associated with the mitigating location; and
determine the mitigating location based upon the output.

17. The at least one non-transitory computer-readable storage medium of claim 13, wherein the telematics data further comprises a current location of the mobile home, and wherein the instructions further cause the at least one processor to:
determine a travel path from the current location to the mitigating location; and
transmit travel instructions associated with the travel path to the user device.

18. The at least one non-transitory computer-readable storage medium of claim 13, wherein the instructions further cause the at least one processor to determine the mitigating location from a plurality of mitigating locations based at least in part upon historical mitigating data associated with damage previously mitigated by the plurality of mitigating locations.

19. A computer-implemented method for tracking activity associated with a plurality of mobile homes using a machine learning model, the computer-implemented method implemented by at least one processor in communication with at least one memory, the computer-implemented method comprising:
wirelessly connecting to a weather services computer device that generates weather data associated with a plurality of locations;
receiving telematics data associated with travel of a mobile home at least partially collected by a plurality of sensors associated with the mobile home, the telematics data comprising a plurality of travel locations of the mobile home and a plurality of durations of time spent by the mobile home at the plurality of travel locations;
receiving current weather data from the weather services computer device, wherein the current weather data is associated with at least one location of the plurality of travel locations;
inputting the telematics data and the current weather data into the machine learning model, the machine learning model trained to assess potentially anomalous weather events with respect to mobile homes based upon historical telematics data and historical weather data;
receiving an output from the machine learning model associated with a potentially anomalous weather event associated with the mobile home;
determining a mitigating location different the current location that would potentially mitigate damage to the mobile home by the potentially anomalous weather event; and
causing an alert to be transmitted to a user device associated with an occupant of the mobile home, the alert comprising an indication of the potentially anomalous weather event and a recommendation to travel to the mitigating location.

20. The computer-implemented method of claim 19, further comprising:
further inputting the telematics data to the machine learning model, the machine learning model further trained to identify mitigating locations that would potentially mitigate damage to the mobile homes from the potentially anomalous weather events;
receiving the output, wherein the output is further associated with the mitigating location; and
determining the mitigating location based upon the output.
